(19) United States
(12) Patent Application Publication
(10) Pub. No.: US 2007/0145722 A1
(43) Pub. Date: Jun. 28, 2007

(54) Scrap material transport cart

(75) Inventors: Chieh-Ming Lin, Miao-Li (TW); Wen-Neng Tseng, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/645,406

(22) Filed: Dec. 26, 2006

(30) Foreign Application Priority Data
Dec. 23, 2005 (TW) 94222585

(51) Int. Cl. B62B 1/00

(52) U.S. Cl. 280/645

(57) ABSTRACT

An exemplary scrap material transport car (100) includes a chassis (120), a plurality of wheels (110), a plurality of supporting rods (130), a container (140), and a pneumatic piston (160). The chassis includes four connection rods (121, 122, 123 and 124) connected sequentially. The chassis has four corners (125, 126, 127 and 128). The wheels are positioned under the corners, and the supporting rods extend from four corners. The housing includes an opening (141), and two pivoting joints. Two of the supporting rods extending from two corners are connected with one of the pivoting joints, and another two supporting rods extending from the other corners are connected with the other one of the pivoting joints. The housing pivots along a pivot axis between the two pivoting joints. The pneumatic piston connects between the connection rod and the bottom surface of the container.

### FIELD OF THE INVENTION

The present invention relates to a transport cart suitable for safely transporting scrap material such as damaged and broken substrates which are produced in various manufacturing facilities.

### BACKGROUND

Liquid crystal displays (LCDs) generally have the advantages of low radiation emissions and low power consumption, as well as being lightweight, thin, and compact. In general, the liquid crystal display includes two substrates and a liquid crystal layer sandwiched between the substrates. Manufacturing processes for liquid crystal displays are complicated. Some of these processes are performed in a clean room which has a constant temperature and good air quality.

The substrates can, for example, be made of silicon glass, and may have thicknesses in a range from hundreds of micrometers to several millimeters. Typically, dozens of different steps are involved in manufacturing of liquid crystal displays. In many of these steps, the silicon glass may easily become damaged or be broken.

At present, damaged and broken substrates are usually transported out of the clean room by hand. As a consequence, many workers risk injury from the sharp edges of broken substrates. In addition, fragments and dust from the broken substrates many contaminate the clean room.

It is therefore desirable to provide equipment that can overcome the above-described deficiencies. In particular, it is desired to provide a scrap material transport cart that is clean, safe, and efficient.

### SUMMARY

An exemplary scrap material transport cart includes a chassis, a plurality of wheels, a plurality of supporting member, a container, a handle frame, and a pneumatic piston. The chassis includes a first connection member, a second connection member, a third connection member and a fourth connection member joined end-to-end to cooperatively form a four-sided closed structure, with a first corner, a second corner, a third corner and a fourth corner. The wheels are arranged at bottom sides selected of the first, second, third, and fourth corners. The supporting members extend from four corners of the chassis. The container includes two pivoting joints positioned on two opposite lateral sides thereof, and an end opening. Two of the supporting members extend from the first and second corners respectively and jointly connecting with one of the pivoting joints. Another two of the supporting members extend from the third and fourth corners respectively and jointly connecting with the other pivoting joints the container being pivotable about a pivot axis defined between the pivoting joints. The handle frame extends from the first corner and the second corner of the chassis. The pneumatic piston positioned at the fourth connection member of the chassis connects between the fourth connection member and a bottom of the container.

Other advantages and novel features will become more apparent from the following detailed description when taken in conjunction with the accompanying drawings, in which:

### BRIEF DESCRIPTION OF THE DRAWINGS

FIG. 1 is a perspective view of a scrap substrate transport cart according to an exemplary embodiment of the present invention, showing a container of the scrap substrate transport cart positioned for carrying substrates; and

FIG. 2 is similar to FIG. 1, but showing the container of the scrap substrate transport cart positioned for dumping a load of damaged and broken substrates.

### DETAILED DESCRIPTION OF PREFERRED EMBODIMENTS

Reference will now be made to the drawings to describe preferred and exemplary embodiments of the present invention in detail.

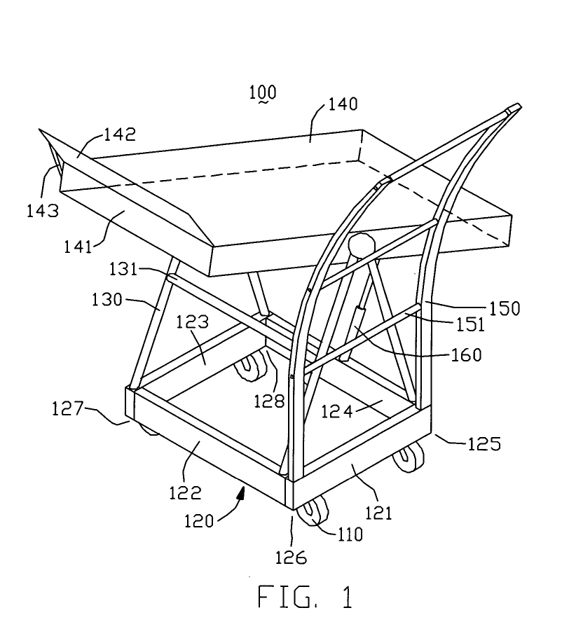

Referring to FIG. 1, a perspective view of a scrap substrate transport cart according to an exemplary embodiment of the present invention is shown. The scrap substrate transport cart 100 includes four wheels 110, a chassis 120, a plurality of supporting rods 130, a container 140, a handle frame 150, and a pneumatic piston 160.

The chassis 120 includes a first connection beam 121, a second connection beam 122, a third connection beam 123, and a fourth connection beam 124, which are joined end-to-end to cooperatively form a four-sided closed structure that is the chassis 120. The chassis 120 includes a first corner 125, a second corner 126, a third corner 127, and a fourth corner 128. The wheels 110 are arranged at bottom sides of the first corner 125, the second corner 126, the third corner 127, and the fourth corner 128 of the chassis 120 so as to movably support the scrap substrate transport cart 100. In addition, the wheels 110 can for example be trolley wheels, whereby the entire assembly of each wheel 110 is rotatable about a vertical axis. The handle frame 150 extends up from the first and second corners 125, 126 of the chassis 120. The handle frame 150 includes a plurality of transverse connection rods 151 for providing the handle frame 150 with mechanical stability.

Two of the supporting rods 130 extend vertically up from the first corner 125 and the second corner 126 respectively, and are jointly connected with one of pivoting joints (not labeled) on a lateral side of the container 140. Another two supporting rods 130 extend from the third corner 127 and the fourth corner 128 respectively, and are jointly connected with another one of the pivoting joints (not labeled) on an opposite lateral side of the container 140. The container 140 is substantially a box-shaped receptacle, and pivots about a pivot axis between the two pivoting joints. The container 140 includes an end opening 141, and a pivotable cover 142 that can cover the opening 141. When damaged or broken substrates need to be loaded into the container 140, the substrates are inserted into the container 140 via the opening 141. When the scrap substrate transport cart 100 with loaded substrates is moved, the opening 141 is covered by the pivotable cover 142 to prevent the substrates from falling out of the container 140. A bottom end of the pneumatic piston 160 is connected with the fourth connection beam 124, and an opposite top end of the pneumatic piston 160 is connected with a bottom of one end of the container 140. The pneumatic piston 160 can be extended or retracted, such that the container 140 pivots about the pivot axis.

The handle frame 150 has a control switch (not shown), which is used to control the pneumatic piston 160. A stop rod 131 is connected between midpoints of the two supporting rods 130 that extend from the second corner 126 and the third corner 127. The stop rod 131 is for limiting a range of angles of inclination of the container 140 to within a predetermined range. A hook (not shown) is provided at the opening 141 of the container 140. When the opening 141 is covered by the pivotable cover 142, the hook is used to fasten the pivotable cover 142 in position. A hydraulic rod 143 is connected with an end of one lateral side of the container 140 at the cover, and with a corresponding side of the pivotable cover 142. The pivotable cover 142 can slowly rotate to cover the opening 141 by means of the hydraulic rod 143. Similarly, the pivotable cover 142 can slowly rotate up away from the opening 141 by means of the hydraulic rod 143.

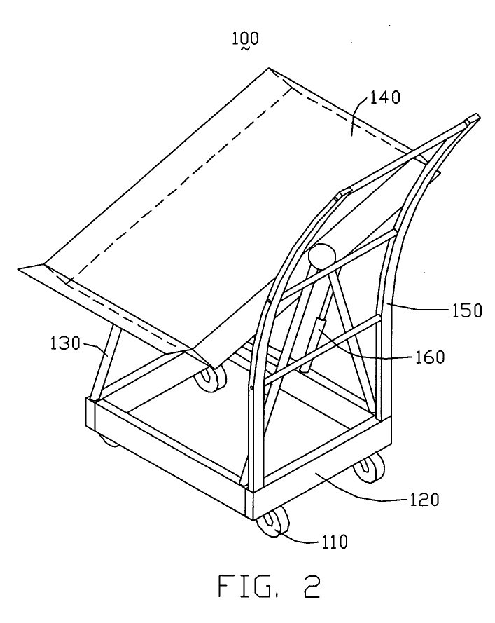

FIG. 2 shows the container 140 of the scrap substrate transport cart 100 positioned for dumping a load of substrates. When the scrap substrate transport cart 100 dumps the substrates, the pneumatic piston 160 is extended so that the end of the container 140 is lifted. The container 140 pivots about the pivot axis, and the opening 141 is lowered. When the container 140 reaches the stop rod 131, the container 140 is stopped from pivoting further. The hydraulic rod 143 is operated so that the pivotable cover 142 rotates up away from the opening 141. In this manner, the substrates loaded in the container 140 are completely dumped.

When the scrap substrate transport cart 100 is loaded with substrates for transportation, the pneumatic piston 160 is retracted and has a minimum length, and the opening 141 is located at a maximum height. Preferably, the container 140 is in a slightly tilted position so that the substrates loaded therein are apt to shift away from the opening 141 if the scrap substrate transport cart 100 is jarred or bumped. Further, when the pivotable cover 142 is in the closed position, the substrates loaded in the scrap substrate transport cart 100 are prevented from falling out of the container 140 even if the scrap substrate transport cart 100 is jarred or bumped.

According to the above-described features, the risk of operators sustaining injury or a clean room being contaminated are significantly reduced, because substrates loaded in the scrap substrate transport cart 100 are prevented from accidentally falling out of the container 140.

It is to be further understood that even though numerous characteristics and advantages of preferred and exemplary embodiments have been set out in the foregoing description, together with details of structures and functions associated with the embodiments, the disclosure is illustrative only, and changes may be made in detail (including in matters of shape, size, and arrangement of parts) within the principles of the invention to the full extent indicated by the broad general meaning of the terms in which the appended claims are expressed.

What is claimed is:

1. A scrap material transport cart, comprising:
a chassis, comprising a first connection member, a second connection member, a third connection member and a fourth connection member joined end-to-end to cooperatively form a four-sided closed structure, with a first corner, a second corner, a third corner and a fourth corner;
a plurality of wheels, arranged at bottom sides of selected of the first, second, third, and fourth corners;
a plurality of supporting members, extending up from the four corners of the chassis;
a container, comprising two pivoting joints positioned on two opposite lateral sides thereof, and an end opening, two of the supporting members extending from the first and second corners respectively and jointly connecting with one of the pivoting joints, and another two of the supporting members extending from the third and fourth corners respectively and jointly connecting with the other pivoting joint, the container being pivotable about a pivot axis defined between the pivoting joints;
a handle frame extending from the first corner and the second corner of the chassis; and
a pneumatic piston positioned at the fourth connection member of the chassis and connected between the fourth connection member and a bottom of the container.

2. The scrap material transport cart as claimed in claim 1, wherein the handle frame has a control switch for controlling extension or retraction of the pneumatic piston.

3. The scrap material transport cart as claimed in claim 2, wherein the pneumatic piston is capable of extending or retracting in a manner such that the container is caused to pivot about the pivot axis.

4. The scrap material transport cart as claimed in claim 3, further comprising a stop member connected between the two supporting members extending from the second corner and the third corner.

5. The scrap material transport cart as claimed in claim 1, wherein a hook is positioned at the opening.

6. The scrap material transport cart as claimed in claim 5, further comprising a cover configured for covering the opening and moving away from the opening, and a hydraulic member connected between an end of a lateral side of the container and the cover.

7. The scrap material transport cart as claimed in claim 1, the handle frame comprises at least one transverse connection rod configured to strengthen and stabilize the handle frame.

8. The scrap material transport cart as claimed in claim 1, wherein the container is structured and arranged to hold scrap substrates discarded in the process of manufacturing liquid crystal display devices.

9. A scrap material transport cart comprising:
a chassis equipped with wheels on a bottom portion; and
a container supportably mounted on the chassis, said container including a bottom plate and a side opening; wherein
the bottom plate is moveable relative to the chassis in a tilted manner so as to be able to not only safely hold damaged glass substrates during transportation under a condition of the side opening is in an upward direction relative to the container but also conveniently dump the damaged glass substrates in a recycle spot under a condition of the side opening is in a downward direction relative to the container.

10. The scrap material transport cart as claimed in claim 9, wherein the container includes a top plate opposite to the bottom plate cooperating with side walls to efficiently hold the damaged glass substrates in the container.

11. The scrap material transport cart as claimed in claim 9, wherein the container is moveable relative to the chassis in a lever manner.

12. The scrap material transport cart as claimed in claim 11, wherein the side opening is located at one end of a lever structure which performs said lever manner while an extendable structure is connected to the other end of said lever structure.

13. The scrap material transport cart as claimed in claim 12, wherein the extendable structure is a piston.
